(19) United States
(12) Patent Application Publication
(10) Pub. No.: US 2012/0137063 A1
(43) Pub. Date: May 31, 2012

(54) AUXILIARY STORAGE DEVICE AND PROCESSING METHOD THEREOF

(75) Inventors: Masahiko Horibe, Nagoya-shi (JP); Tsukasa Ito, Nagoya-shi (JP)

(73) Assignee: Buffalo Inc., Nagoya-shi (JP)

(21) Appl. No.: 13/302,313

(22) Filed: Nov. 22, 2011

(30) Foreign Application Priority Data
Nov. 26, 2010 (JP) 2010-263319

(51) Int. Cl. G06F 12/08

(52) U.S. Cl. 711/113; 711/118; 711/E12.019

(57) ABSTRACT

A storage device that receives writing data with a first data size from a host, and writes data with a second data size that is greater than the first data size. The storage device includes a storage area unit formatted and managed by a file format including user data and specific management data, the user data and specific management data having a size smaller than the second data size, a cache memory having a capacity of not less than the second data size and that stores the specific management data, and a controller that controls reading and writing data from and into the storage area unit and the cache memory, when receiving an instruction from the host.

### CROSS-REFERENCE TO RELATED APPLICATION

This application claims the benefit of priority under 35 U.S.C. §119 to Japanese Patent Application No. 2010-263319 filed on Nov. 26, 2010, the disclosure of which is hereby incorporated by reference in its entirety.

### BACKGROUND

1. Technical Field

The present disclosure relates to an auxiliary storage device having emulation function of reading and writing data in the greater data size than the data size accessed by a host, and a processing method thereof.

2. Related Art

Hard disk drives disclosed in JP 2010-49764A and JP 2005-63441 A have been known as the auxiliary storage device having the emulation function. The hard disk drive generally requires a file management program (hereinafter called “file system”) for operations and management of files. The file system is provided as part of the functions of the operating system in the general computer system. A specific example of the file system is the commonly used FAT (File Allocation Table) file system. A hard disk drive according to the FAT file system processes data in units of sectors, wherein one sector is generally equal to 512 bytes.

Recently, with a significant increase in data volume, the hard disk drive has adopted the emulation function of reading and writing data in the greater data size than the data size accessed by the host, in order to improve the access speed. More specifically, the hard disk drive having the emulation function is accessed in units of 512 bytes by the host, while reading and writing data from and into the hard disk unit in units of 4096 bytes (4 K bytes). Accordingly, in response to a write request of data having the volume of less than 4 K bytes from the host, the controller of the hard disk drive reads 4 K-byte data from an object sector, combines data to generate 4 K-byte writing data in the memory of the controller and collectively writes the 4 K-byte data. In this manner, in response to a write request of data having the volume of less than 4 K bytes from the host, the conventional technique (i) reads out a 4 K-byte sector from the hard disk, (ii) combines the reading data with writing data and (iii) writes the combined data into the hard disk. This technique requires a considerably long time period for data writing.

Additionally, in the hard disk drive having such emulation function, specific management data having 512-byte data volume is stored in a specific sector and is frequently accessed by the host. The conventional technique cannot write this specific management data alone in the unit of 512-byte data, but should read the specific management data together with data other than the specific management data in the unit of 4 K bytes, update only the specific management data out of the reading data and write the updated specific management data together with the non-updated other data in the unit of 4 K bytes into the disk. This method requires the reading operation simultaneously with every writing operation of the specific management data, thus lowering the processing speed. This problem is not limited to the hard disk drive but is commonly found in other auxiliary storage devices, such as SSD (Solid State Drive).

Consequently, there is a need to improve the writing speed in the auxiliary storage device having the emulation function of reading and writing data in the greater data size than the data size accessed by the host.

### SUMMARY

According to a first exemplary embodiment, the disclosure is directed to a storage device that receives writing data with a first data size from a host, and writes data with a second data size that is greater than the first data size. The storage device includes a storage area unit formatted and managed by a file format including user data and specific management data, the user data and specific management data having a size smaller than the second data size, a cache memory having a capacity of not less than the second data size and that stores the specific management data, and a controller that controls reading and writing data from and into the storage area unit and the cache memory, when receiving an instruction from the host. The controller stores, in advance into the cache memory, data with the second data size that is stored in the storage area unit and includes the specific management data, and when receiving a write instruction from the host, overwrites the specific management data stored in the cache memory with new specific management data supplied from the host, and writes data having the second data size stored in the cache memory and including the overwritten specific management data into the storage area unit.

According to another exemplary embodiment, the disclosure is directed to method performed by a storage device including a host interface accessed from a host in a first data size, a cache memory that stores data, and a storage area unit that stores data, wherein the storage device receives writing data with the first data size from the host, and writes data into the storage area unit with a second data size that is greater than the first data size. The method comprising formatting the storage area unit by a file format including user data and specific management data, the user data and specific management data having a size smaller than the second data size; storing the specific management data in advance in the cache memory; and when receiving a write instruction from the host, overwriting the specific management data stored in the cache memory with new specific management data supplied from the host, and writing data having the second data size stored in the cache memory and including the overwritten specific management data into the storage area unit.

### BRIEF DESCRIPTION OF THE DRAWINGS

FIG. 1 schematically shows the configuration of an information processing system according to one embodiment of the disclosure;

FIG. 2 shows the memory map of a disk formatted by the FAT system;

FIG. 3 is a flowchart showing a processing flow performed at start-up of a personal computer;

FIG. 4 is a flowchart showing a processing flow performed by the personal computer and the controller;

FIG. 5 shows a process of transferring management data;

FIG. 6A shows a process subsequent to FIG. 5;

FIG. 6B shows a process subsequent to FIG. 6A;

FIG. 6C shows a process subsequent to FIG. 6B;

FIG. 7A shows a process subsequent to FIG. 6C;

FIG. 7B shows a process subsequent to FIG. 7A; and

FIG. 8 schematically shows the configuration of an information processing system according to another embodiment.

### DETAILED DESCRIPTION

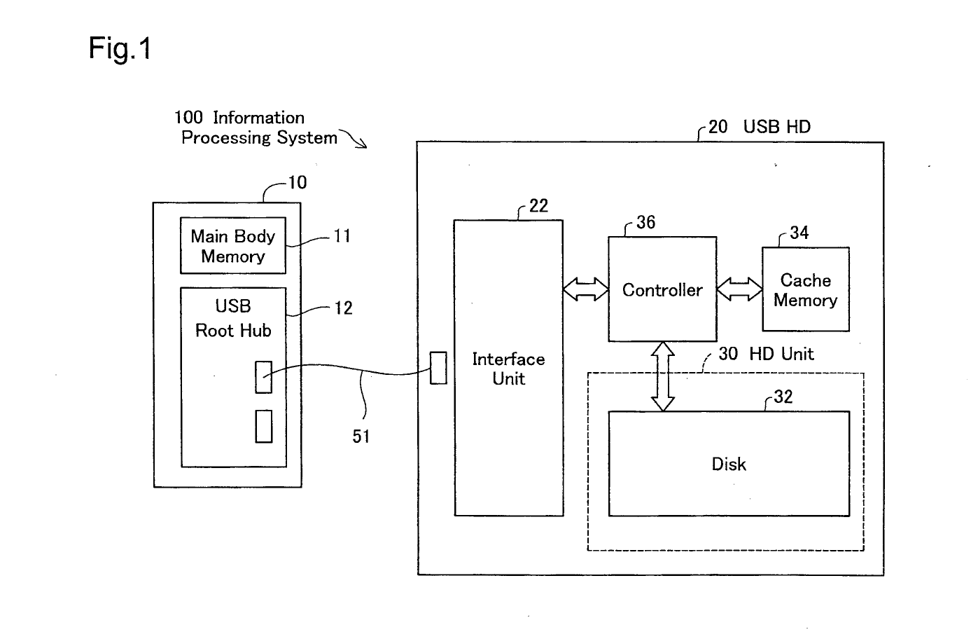

An information processing system including a hard disk drive according to one embodiment of the disclosure is described. FIG. 1 schematically shows the configuration of an information processing system 100 according to one embodiment of the disclosure. As illustrated, the information processing system 100 includes a personal computer 10 (host) as an information processing device and a USB hard disk drive 20. The personal computer 10 includes a main body memory 11 and a USB root hub 12 to allow for connection of a USB device. In this embodiment, the hard disk drive 20 as a USB device is connected with the personal computer 10 via a USB cable 51.

The hard disk drive 20 includes an interface unit 22, a hard disk unit 30 including a disk 32 as a recording medium, a cache memory 34 having 4 K-byte capacity and a controller 36. The interface unit 22 serves as an interface for USB connection to the personal computer 10.

The controller 36 is connected with the interface unit 22, the hard disk unit 30 and the cache memory 34 and controls writing to and reading from the disk 32. More specifically, the controller 36 performs processes of, for example, writing data sent from the interface unit 22 into the disk 32 or the cache memory 34 and reading out data stored in the disk 32 and storing the reading data into the cache memory 34. The cache memory 34 is a RAM for temporarily storing data and is used by the controller 36 to adjust the size of writing data to the 4 K-byte data size and write the size-adjusted data into the disk 32. In this embodiment, the controller 36 is a microcomputer including a CPU and a memory. Alternatively the controller 36 may be comprised of plural discrete electronic parts, instead of the microcomputer.

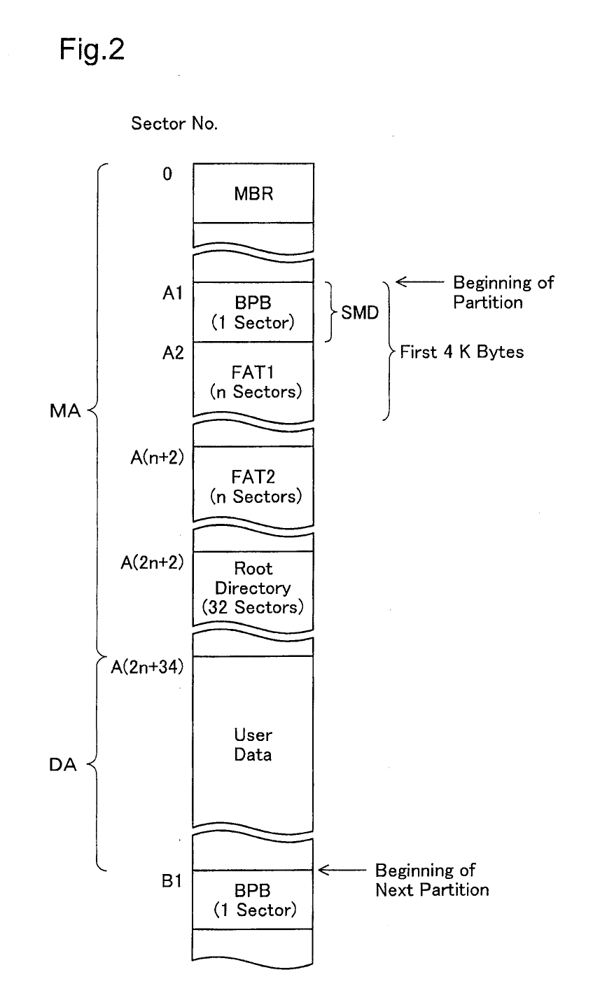

The hard disk unit 30 includes data required for activating a startup object system (for example, a program executed first at the power supply), as the data stored on the disk 32 according to the structure of the FAT file system. FIG. 2 shows the memory map of the disk 32 formatted by the FAT file system. The FAT file system divides the disk 32 into 512-byte logical units called sectors. The controller 36 has emulation function read and written by 4 K bytes in units of plural sectors. Information for identifying the sector in which data of a certain file is present and for checking whether a certain sector is currently in use or not in use is recorded in a management area MA on the disk 32.

According to the FAT system format, the storage area of the disk 32 is divided into a management area MA and a user data area DA. The management area MA includes plural areas called Master Boot Record (MBR), BIOS Parameter Block (BPB), FAT1, FAT2 and Root Directory. The data structure of the FAT system is known in the art, so that the respective areas are only briefly explained. The FAT file system typically manages data in units of sectors. When the sector size of the disk 32 is 512 bytes and the cluster size is 4 K bytes, one cluster consists of 8 sectors and the data is processed in units of 8 sectors.

The MBR is the area read first by the personal computer 10 when the hard disk drive 20 is connected to the personal computer 10 and stores a bootstrap code and a partition table. The partition table stores information including the number of partitions generated, the first sector and the last sector of each partition, the offset, and the total number of sectors.

The BPB is recorded in the first sector of each partition and stores management data including the format of the partition, the number of sectors and the number of FATs, as various pieces of information on the format of the disk 32. The management data stored in the BPB may include a flag indicating that the disk 32 is during file writing operation (if applicable). In the description hereof, the data stored in the BPB is also called “specific management data SMD”. In the illustrated example of FIG. 2, the disk 32 is divided into two partitions, and the BPB is provided in the first sectors A1 and B1 of the respective partitions. Occasionally, however, the disk 32 may have only one partition.

Information on the cluster chain of each file stored in the user data area DA is recorded in both the FAT1 and FAT2. Recording the same information in the FAT1 and FAT2 ensures the validity of data when the data stored in the disk 32 is read into the system. The number of sectors “n” in the FAT1 and FAT2 is specified by a parameter in the BPB.

The root directory stores, for example, the file name, the extension and attribute of a file in the root and the first cluster number of the file.

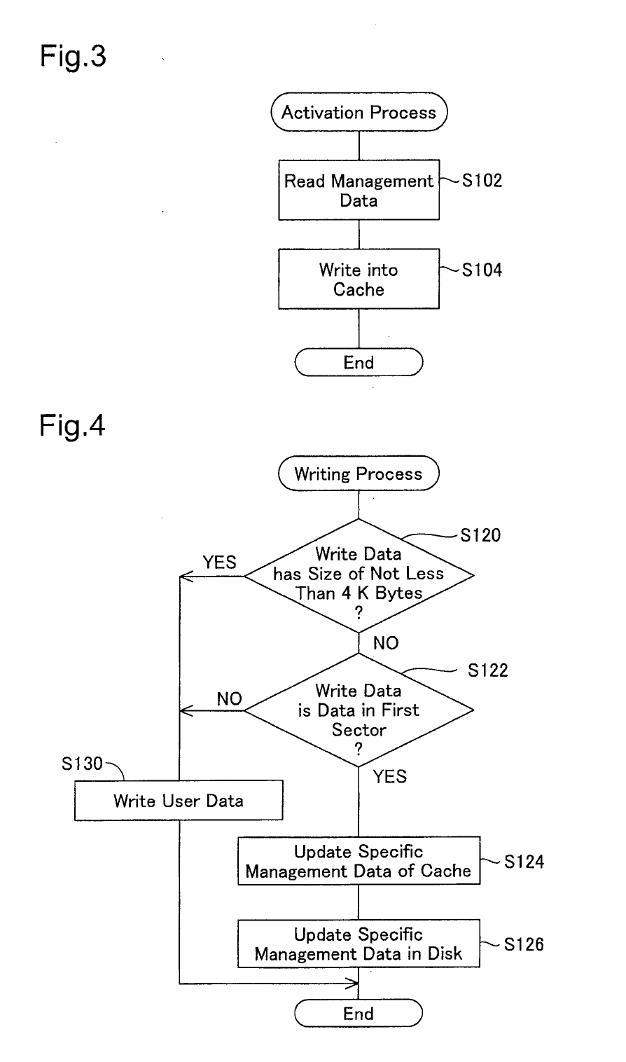

This embodiment uses the cache memory 34 to perform an activation process of the hard disk and a writing process into the hard disk as described below. FIGS. 3 and 4 are flowcharts showing the processing flows performed by the personal computer 10 and the controller 36. Many of FAT drivers implemented on the personal computer 10 raises a flag at the first sector (BPB) of a partition before writing user data into the hard disk and lowers the flag after writing the user data. Accordingly, the process of writing data into the hard disk typically follows the sequence of (i) writing the BPB with flag ON; (ii) writing user data; and (iii) rewriting the BPB with flag OFF. The process follows this sequence especially when a new file is to be added or when the file size is to be increased. The following describes the processing in such cases. The following description is mainly on the assumption that there is only one partition in the disk 32.

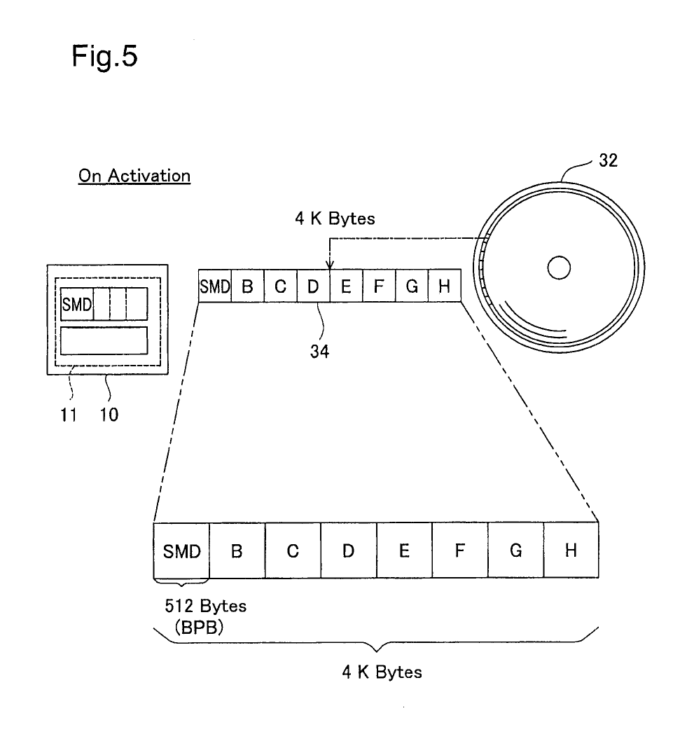

FIG. 3 is a flowchart showing the activation process performed by the controller 36 at the start-up of the personal computer 10. FIG. 5 shows the process of data transfer between the personal computer 10, the disk 32 and the cache memory 34. When the personal computer 10 shown in FIG. 1 is powered on to activate the BIOS (Basic Input/Output System), the data stored in the disk 32 of the hard disk unit 30 is read into the personal computer 10 via the interface unit 22. Referring to FIG. 3, at step S102, the controller 36 reads the 4 K-byte data from the first sector in the partition of the disk 32, i.e., the first 4 K-byte data including the specific management data SMD in the BPB (FIG. 2) (FIG. 5). The controller 36 then writes the read 4 K-byte data into the cache memory 34 at step S104. As a result, the 512-byte specific management data SMD is stored in the first memory area of the cache memory 34, and data B to H are stored in the subsequent memory areas, as shown in FIG. 5. The data B to H are generally part of the FAT1 (FIG. 2).

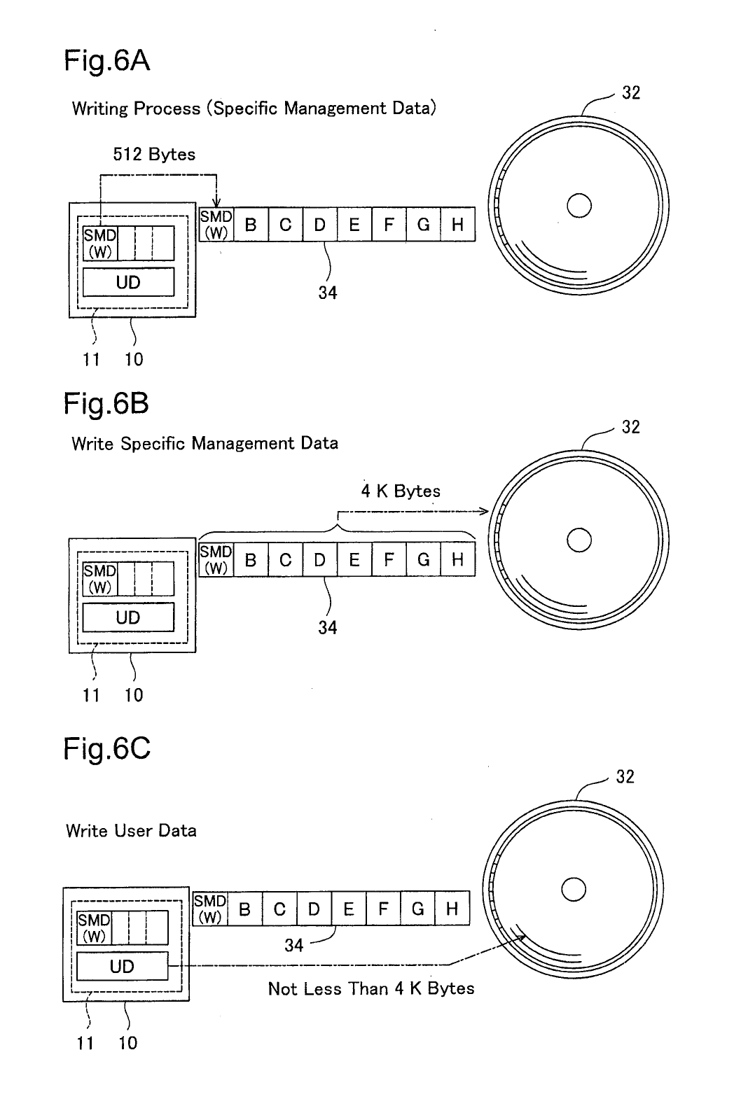

FIG. 4 is a flowchart showing the writing process of data from the personal computer 10 into the hard disk unit 30. The controller 36 starts the writing process, in response to a write instruction from the personal computer 10 to the hard disk unit 30. Referring to FIG. 4, in the course of writing the writing data sent from the personal computer 10 into the hard disk unit 30, the controller 36 first checks whether the writing data has the size of not less than 4 K bytes at step S120. The writing data may be either the specific management data SMD or the user data. At subsequent step S122, the controller 36 checks whether the writing data is the data in the first sector of the partition. As explained previously, the specific management data SMD has the size of 512 bytes and is the data in the first sector of the partition. Accordingly, the check results of steps S120 and S122 show whether the writing data is the specific management data SMD. When the writing data is the specific management data SMD, the specific management data SMD is provided as specific management data SMD(W) including a flag that indicates start of data writing and has been set by the personal computer 10. When affirmative answers are given at steps S120 and S122, the processing flow goes to step S124 to update (overwrite) the specific management data SMD of the cache memory 34. FIGS. 6A and 6B show the process when the writing data is the specific management data SMD. As shown in FIG. 6A, the controller 36 updates the 512-byte data of the first sector in the 4 K-byte data of the cache memory 34 with the specific management data SMD(W) sent from the personal computer 10. At subsequent step S126, the controller 36 writes the data including the specific management data SMD(W) into the disk 32. Since it is not allowed to write only the 512-byte specific management data SMD(W) into the disk 32, the 4 K-byte data including the other data B to H present in the cache memory 34 is wholly written into the disk 32, as shown in FIG. 6B. When the specific management data SMD has varying size data, the 4 K-byte data including the specific management data SMD may wholly be updated.

When the check results of steps S120 and S122 show that the writing data sent from the personal computer 10 is user data UD excluding the first 4 K-byte data of the partition, the processing flow goes to step S130 to perform ordinary writing operation of the user data UD. The user data UD has the size of not less than 4 K bytes and is not the data in the first sector of the partition, so that the ordinary writing operation shown in FIG. 6C is performed. In this case, the data in the cache memory 34 is maintained in the state of FIG. 6B. It may thus be desired that the cache memory 34 constantly stores the specific management data SMD, irrespective of access history to the disk 32 by the controller 36.

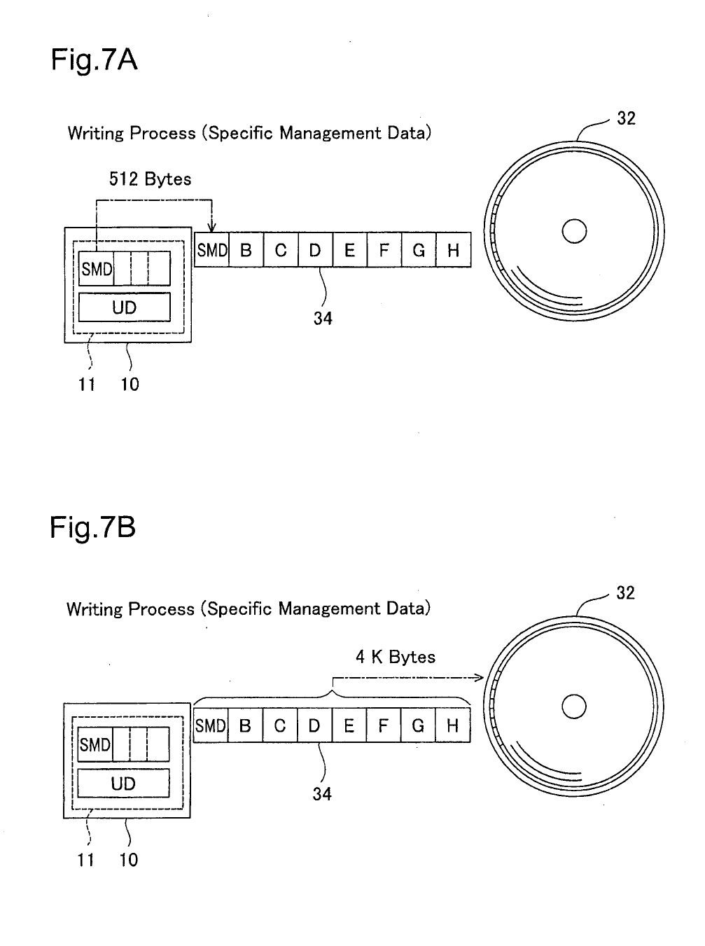

When the 512-byte specific management data SMD is sent again after all the user data UD has been written, i.e., when the specific management data SMD including a flag indicating completion of data writing, the processing flow of steps S120 to S126 shown in FIG. 4 is performed. As a result, after the specific management data SMD of the cache memory 34 is updated as shown in FIG. 7A, the 4 K-byte data of the cache memory 34 is written into the disk 32 as shown in FIG. 7B.

The hard disk unit 30 according to this embodiment has the following functions and advantageous effects.

(1) In the hard disk drive 20 of the embodiment, the data writing process writes the specific management data SMD into the disk 32 before and after writing the user data UD. The specific management data SMD having the data size of 512 bytes is written into the cache memory 34. The 4 K-byte data in the cache memory 34 is adjusted, the adjusted 4 K-byte data is written from the cache memory 34 into the disk 32. Unlike the conventional technique, this method does not require to read the 4 K-byte data including the specific management data SMD from the disk 32 every time the specific management data SMD is to be written, thus improving the processing speed.

(2) The cache memory 34 for the specific management data contained in the hard disk drive 20 has the relatively small storage capacity of, for example, 4 K bytes, unlike the large-capacity cache memory for user data. Another cache memory for user data may, however, be provided, in addition to the cache memory 34 for the specific management data.

(3) Reading and writing the specific management data SMD from and into the cache memory 34, the personal computer 10 and the disk 32 are performed by the software contained on the controller 36 of the hard disk drive 20. Accordingly, this does not require any complicated operation or configuration, e.g., setting part of the main body memory 11 of the personal computer 10 as a cache memory or changing the program in the personal computer 10.

(4) In the course of updating data by the personal computer 10, the specific management data SMD is updated by the writing process from the cache memory 34 into the disk 32, so that the specific management data SMD in the disk 32 is not lost even in the event of unintentional power shutdown.

The disclosure is not limited to the above embodiment but various modifications may be made to the embodiment without departing from the scope of the disclosure. Some of possible modifications are given below.

(1) The above embodiment writes the specific management data SMD into the cache memory 34 at step S124 and writes the data of the cache memory 34 into the disk 32 at step S126 in FIG. 4, every time the specific management data SMD is sent to the hard disk drive 20. One modification may write the specific management data into the disk when the ratio of idling state with no writing into the disk 32 is not less than a preset level, thus further improving the processing speed of data writing.

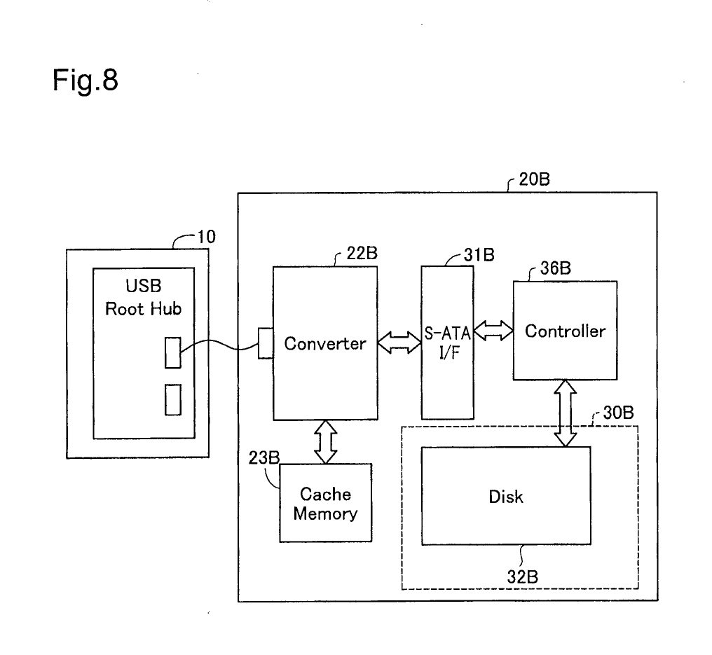

(2) FIG. 8 schematically illustrates the configuration of an information processing system according to another embodiment. This embodiment applies the process to a SATA (Serial Advanced Technology Attachment) as an interface of a hard disk drive 20B. More specifically, the hard disk drive 20B includes a converter 22B, a cache memory 23B connected with the converter 22B, a hard disk unit 30B including a disk 32B, a SATA interface 31B and a controller 36B. The converter 22B has the function of converting serial signals of the USB standard into SATA signals and includes a program for controlling the specific management data SMD temporarily stored in the cache memory 23B. In this manner, the hard disk drive 20B may be implemented by using the general-purpose SATA hard disk unit 3013. The program for controlling the specific management data SMD may alternatively be included in the controller 36B.

(3) The various computer programs described above may be stored in advance in the ROM or may be stored in the disk 32. Otherwise the computer programs may be stored and distributed in any of various storage media (including computer readable recording media), e.g., a CD-ROM, or may be delivered through any of various communication means, such as the Internet.

(4) Although the device using the File Allocation Tables including FAT32 as the highly effective file system is described in the above embodiment, the disclosure is not restricted to this embodiment but may also be applicable to a device using any other appropriate file system, for example, NTFS (New Technology File System). Additionally, in the file format of the FAT or another file system, MBR or data in another system area (management area) may be included, in place of or in addition to the BPB data, as the specific management data stored in the cache memory.

(5) Although the cache memory 34 and the controller 36 are located outside the hard disk unit 30 in the above embodiment, the disclosure is not restricted to this configuration but may also be applicable to the configuration in which the cache memory 34 and the controller 36 are incorporated in the hard disk unit 30.

(6) In the above embodiment, the cache memory 34 stores the specific management data SMD (for example, BPB) of the first partition of the disk 32, irrespective of access history to the disk 32 by the controller 36. When the disk 32 is divided into plural partitions, the respective partitions individually store specific management data SMD. In this case, the cache memory 34 may store all the plural specific management data SMD for the plural partitions. Alternatively the cache memory 34 may store only one specific management data SMD (for example, BPB) for a partition lately accessed by the controller 36 or the host.

(7) Although the cache memory 34 has the same storage capacity as the unit of access (4 K bytes) to the disk 32 in the above embodiment, the cache memory 34 may have a greater storage capacity.

(8) The disclosure is not restricted to the hard disk drive but may also be applicable to various auxiliary storage devices, for example, SSD (Solid State Drive). The SSD has the storage area consisting of a flash memory, differently from the hard disk drive having the storage area consisting of the disk. The SSD and the hard disk drive are, however, common in that the data in the storage area is formatted according to the file format including user data and specific management data. As clearly understood from this explanation, the disclosure is generally applicable to an auxiliary storage device that receives writing data of a first data size from a host and writes data in a second data size, which is greater than the first data size and is an integral multiple of the first data size.

What is claimed is:

1. A storage device that receives writing data with a first data size from a host, and writes data with a second data size that is greater than the first data size, the storage device comprising:
a host interface that is accessed from the host in a volume of the first data size;
a storage area unit that is formatted and managed by a file format including user data and specific management data, the user data and specific management data having a size smaller than the second data size;
a cache memory having a capacity of not less than the second data size and that stores the specific management data; and
a controller that controls reading and writing data from and into the storage area unit and the cache memory, when receiving an instruction from the host, wherein
the controller stores, in advance into the cache memory, data with the second data size that is stored in the storage area unit and includes the specific management data, and when receiving a write instruction from the host, overwrites the specific management data stored in the cache memory with new specific management data supplied from the host, and writes into the storage area unit, data having the second data size stored in the cache memory and including the overwritten specific management data.

2. The storage device according to claim 1, wherein the storage device is a hard disk drive.

3. The storage device according to claim 2, wherein the storage area unit is a disk of the hard disk drive.

4. The storage device according to claim 1, wherein the first data size is 512 bytes and the second data size is 4096 bytes

5. The storage device according to claim 1, wherein the specific management data has a fixed data size.

6. The storage device according to claim 5, wherein the specific management data is 512-byte data stored in a preset sector of the storage area unit.

7. The storage device according to claim 1, wherein the cache memory iteratively stores the specific management data irrespective of access history to the storage area unit by the controller.

8. The storage device according to claim 1, wherein the storage area unit is divided into a plurality of partitions.

9. The storage device according to claim 8, wherein the plurality of partitions each store the specific management data at respective preset locations.

10. The storage device according to claim 9, wherein the cache memory stores one specific management data for a partition most recently accessed by the controller, out of the specific management data for the plurality of partitions.

11. A processing method performed by a storage device, the storage device including a host interface accessed from a host in a first data size, a cache memory that stores data, and a storage area unit that stores data, wherein the storage device receives writing data with the first data size from the host, and writes data into the storage area unit with a second data size that is greater than the first data size, the method comprising:
formatting the storage area unit by a file format including user data and specific management data, the user data and specific management data having a size smaller than the second data size;
storing the specific management data in advance in the cache memory; and
when receiving a write instruction from the host, overwriting the specific management data stored in the cache memory with new specific management data supplied from the host, and writing into the storage area unit, data having the second data size stored in the cache memory and including the overwritten specific management data.

12. The method according to claim 11, wherein the storage device is a hard disk drive.

13. The method according to claim 12, wherein the storage area unit is a disk of the hard disk drive.

14. The method according to claim 11, wherein the first data size is 512 bytes and the second data size is 4096 bytes

15. The method according to claim 11, wherein the specific management data has a fixed data size.

16. The method according to claim 15, wherein the specific management data is 512-byte data stored in a preset sector of the storage area unit.

17. The method according to claim 11, further comprising:
iteratively storing the specific management data to the cache memory intervals irrespective of access history to the storage area unit by the controller.

18. The method according to claim 11, wherein the storage area unit is divided into a plurality of partitions.

19. The storage device according to claim 18, wherein the plurality of partitions each store the specific management data at respective preset locations.

20. The method according to claim 19, wherein the storing includes storing one specific management data for a partition most recently accessed by the controller, out of the specific management data for the plurality of partitions.
